(19) United States
(12) Patent Application Publication
(10) Pub. No.: US 2025/0038183 A1
(43) Pub. Date: Jan. 30, 2025

(54) POSITIVE ELECTRODE COMPOSITE MATERIAL, PREPARATION METHOD THEREOF, POSITIVE ELECTRODE AND LITHIUM ION SECONDARY BATTERY

(71) Applicant: MURATA MANUFACTURING CO., LTD., Kyoto (JP)

(72) Inventors: Yuli LI, Shanghai (CN); Li WANG, Shanghai (CN); Kazumasa TAKESHI, Shanghai (CN); Siming YANG, Shanghai (CN)

(21) Appl. No.: 18/778,499

(22) Filed: Jul. 19, 2024

(30) Foreign Application Priority Data
Jul. 28, 2023 (CN) 202310944677X

(51) Int. Cl. H01M 4/36; C01G 53/00; H01M 4/02; H01M 4/1315; H01M 4/525; H01M 4/62; H01M 10/0525; H01M 10/42

(52) U.S. Cl. CPC H01M 4/366; C01G 53/42; H01M 4/1315; H01M 4/525; H01M 4/62; H01M 10/0525; H01M 10/4235; C01P 2002/52; C01P 2004/84; C01P 2006/40; H01M 2004/028

(57) ABSTRACT

A positive electrode composite material, a preparation method thereof, a positive electrode and a lithium ion secondary battery are provided. The positive electrode composite material includes a high-nickel positive electrode material; a lithium boron oxide coating a part of the surface of the high-nickel positive electrode material; and fluoride present in a dotted form on the other part of the surface of the high-nickel positive electrode material, the amount of residual lithium on the surface of the positive electrode composite material is less than about 0.3 wt %.

### CROSS REFERENCE TO RELATED APPLICATIONS

The present application claims a priority to Chinese patent application no. 202310944677X, filed on Jul. 28, 2023, and titled “Positive Electrode Composite Material, Preparation Method Thereof, Positive Electrode and Lithium Ion Secondary Battery”, the entire contents of which are incorporated herein by reference.

The present disclosure relates to the field of lithium ion secondary batteries.

In recent years, along with the continuous development of electronic technology, demand of people for a battery apparatus supporting energy supply of an electronic device is also increasing continuously. Today, batteries capable of storing more electric quantity and capable of outputting high power are needed. Conventional lead-acid batteries and nickel-hydrogen batteries, etc. have been unable to meet the requirements of new electronic products such as mobile devices such as smart phones and fixed devices such as power storage systems, etc., Therefore, lithium ion batteries have attracted people's wide attention. In the development process of lithium ion batteries, the capacity and performance thereof have been improved effectively.

A lithium ion secondary battery comprises a positive electrode containing a positive electrode material, a negative electrode, and an electrolyte. The configuration of the positive electrode material has a large effect on the performance of the lithium ion secondary battery. Various studies have been carried out regarding the configuration of the positive electrode material. The content of residual alkali (LiOH and Li₂CO₃) on the surface of a high-nickel positive electrode material is relatively high, resulting in poor processing performance thereof; and the residual lithium may lead to gas generation of the battery, and the more the residual lithium is, the more serious the gas generation is. Therefore, reducing the amount of residual lithium on the surface of the high-nickel positive electrode material becomes the current research emphasis. The practice in the prior art is to reduce the residual lithium on the surface of the high-nickel positive electrode material by means of water washing for modification, and the residual lithium will be greatly reduced; however, at the same time, NiO-based substances will be generated on the surface of the material, resulting in an increase in impedance, and lattice lithium precipitates, resulting in instability of the structure of material and a significant deterioration in the cycle performance.

Improvement, for example, in the cycle and ameliorate the impedance increase of the lithium ion secondary battery are thus needed.

### SUMMARY

The present application relates to the field of lithium ion secondary batteries. More specifically, for example, the present application relates to a positive electrode composite material, a method for preparing the positive electrode composite material, and a positive electrode and a lithium ion secondary battery which comprise the positive electrode composite material. The present application relates to providing, in an embodiment, a positive electrode composite material, a method for preparing the positive electrode composite material, and a positive electrode and a lithium ion secondary battery which comprise the positive electrode composite material, so as to solve the problems of the positive electrode material in the prior art that it is difficult to effectively improve the cycle and ameliorate the impedance increase of the lithium ion secondary battery.

According to an embodiment of the present application, provided is a positive electrode composite material, the positive electrode composite material comprising: a high-nickel positive electrode material; a lithium boron oxide coating a part of the surface of the high-nickel positive electrode material; and fluoride present in a dotted form on the other part of the surface of the high-nickel positive electrode material, the amount of residual lithium on the surface of the positive electrode composite material is less than about 0.3 wt %.

Further, in the positive electrode composite material, in an embodiment, the lithium boron oxide is uniformly covered on the surface of secondary particles and grain boundaries of primary particles of the high-nickel positive electrode material.

Further, in the positive electrode composite material, in an embodiment, the lithium boron oxide includes one or more of LiBO₂, Li₃BO₃, Li₂B₄O₇, Li₂B₂O₄ and Li₃B₃O₆.

Further, in the positive electrode composite material, in an embodiment, the fluoride includes LiF.

Further, in the positive electrode composite material, in an embodiment, the fluoride also includes one or more of MgF₂, AlF₃, NH₄F, MnF₄, TiF₃, ZrF₄, SrF₃ and MoF₅.

Further, in the positive electrode composite material, in an embodiment, the high-nickel positive electrode material has a general formula LiNiₓCo_{y}M_{1-x-y}O₂, where about 0.6≤x≤ about 1, about 0≤y<about 0.4, and M is one or more of Mn, Al, Mg, Ti, Fe, Cu, Zn, Ga, Zr, Mo, Nb and W.

Further, in the positive electrode composite material, in an embodiment, the amount of boron element in the positive electrode composite material is in the range of about 0.01 wt % to about 0.50 wt %.

Further, in the positive electrode composite material, in an embodiment, the amount of fluorine element in the positive electrode composite material is in the range of about 0.01 wt % to about 1.00 wt %.

According to another embodiment of the present application, provided is a method for preparing a positive electrode composite material, the method comprising: step S1: mixing a high-nickel positive electrode material with water or a solution formed by an acid and a non-aqueous solvent, to obtain a first mixture; step S2: performing suction filtration on the first mixture to obtain a suction filtration product, and then performing vacuum drying and grinding and sieving on the suction filtration product, to obtain a washing product; step S3: performing ball-milling mixing on the washing product and a boron-containing compound and fluoride, to obtain a second mixture; and step S4: sintering the second mixture, to obtain the positive electrode composite material.

Further, in the method for preparing the positive electrode composite material, in an embodiment, in the step S1, the acid comprises an organic acid, an inorganic acid or a mixture thereof; preferably, the organic acid comprises one or more of maleic acid, acrylic acid, fumaric acid, malonic acid, oxalic acid, malic acid, glycolic acid, succinic acid, citric acid, tricarballylic acid and aconitic acid, and preferably, the inorganic acid comprises one or both of phosphoric acid and silicic acid.

Further, in the method for preparing the positive electrode composite material, in an embodiment, in the step S1, the non-aqueous solvent comprises an alcoholic solvent, and preferably, the alcoholic solvent comprises one or more of methanol, ethanol, isopropanol, ethylene glycol and glycerol.

Further, in the method for preparing the positive electrode composite material, in an embodiment, in the step S2, the temperature of performing the vacuum drying is in the range of about 60° C. to about 150° C., and the time of performing the vacuum drying is in the range of about 0.1 h to about 12 h.

Further, in the method for preparing the positive electrode composite material, in an embodiment, in the step S3, the rotational speed of performing the ball-milling mixing is in the range of about 100 rpm to about 500 rpm, and the time of performing the ball-milling mixing is in the range of about 10 min to about 2 h.

Further, in the method for preparing the positive electrode composite material, in an embodiment, in the step S3, the fluoride includes one or more of LiF, MgF₂, AlF₃, NH₄F, MnF₄, TiF₃, ZrF₄, SrF₃ and MoF₅.

Further, in the method for preparing the positive electrode composite material, in an embodiment, in the step S3, the boron-containing compound includes one or both of boric acid and boron oxide.

Further, in the method for preparing the positive electrode composite material, in an embodiment, in the step S4, the temperature for the sintering is in the range of about 200° C. to about 600° C., and the time for the sintering is in the range of about 2 h to about 8 h, preferably, the heating rate is in the range of about 6° C./min to about 15° C./min, and preferably, an atmosphere for the sintering is oxygen.

According to still another embodiment of the present application, provided is a positive electrode of a lithium ion secondary battery, the positive electrode of the lithium ion secondary battery comprising the positive electrode composite material as described above.

According to yet another embodiment of the present application, provided is a lithium ion secondary battery, the lithium ion secondary battery comprising: a positive electrode, a negative electrode and a separator, the positive electrode comprising the positive electrode composite material as described above.

By the positive electrode composite material, the method for preparing the positive electrode composite material, and the positive electrode and the lithium ion secondary battery which comprise the positive electrode composite material, in an embodiment, the amount of residual lithium can be effectively reduced, side reactions between the positive electrode composite material and the electrolyte in the lithium ion secondary battery can be suppressed, the initial Coulombic efficiency of the lithium ion secondary battery can be improved, the cycle performance of the lithium ion secondary battery can be improved and the impedance increase of the lithium ion secondary battery can be reduced.

### BRIEF DESCRIPTION OF THE FIGURES

FIG. 1 shows a schematic structural diagram of a positive electrode composite material according to an embodiment of the present disclosure.

FIG. 2 shows a schematic diagram of a method for preparing a positive electrode composite material according to an embodiment of the present disclosure.

### DETAILED DESCRIPTION

It is to be noted that examples in the present application and features in the examples may be combined in any suitable manner according to an embodiment. Hereinafter, the present disclosure will be described in further detail including with reference to examples according to an embodiment. The following examples are merely exemplary, and the present application is not limited thereto.

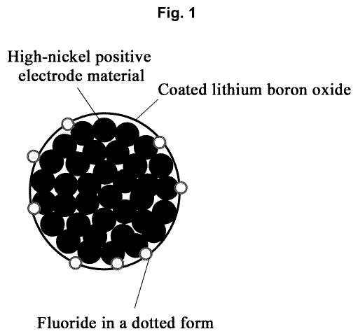

As explained in the Background, it is difficult to effectively improve the cycle and ameliorate the impedance increase of the lithium ion secondary battery. In an embodiment, the present disclosure provides a positive electrode composite material, the positive electrode composite material comprising: a high-nickel positive electrode material; a lithium boron oxide coating a part of the surface of the high-nickel positive electrode material; and fluoride present in a dotted form on the other part of the surface of the high-nickel positive electrode material, the amount of residual lithium on the surface of the positive electrode composite material is less than about 0.3 wt %. FIG. 1 shows a schematic structural diagram of a positive electrode composite material according to an embodiment.

The capacity of the high-nickel positive electrode material can be greatly improved as the Ni content is increased, however, the material has a high residual alkali, a high impedance and poor cycle performance. The cleaning technique of water washing or acid washing can reduce the residual alkali on the surface of the material, but the cycle improvement is small. By performing boron coating after cleaning, the impedance can be ameliorated and the cycle performance can be further improved, however, a reaction between the high-nickel positive electrode material and an electrolyte cannot be effectively suppressed, and the improvement of the cycle performance and the amelioration of the impedance increase are limited. By fluorine coating, the reaction between the high-nickel positive electrode material and the electrolyte can be suppressed, the cycle retention rate is improved, and the impedance increase is suppressed, however, agglomeration easily occurs during fluorine coating, and compared with boron coating, the fluorine coating leads to a relatively high initial impedance. In addition, by coating both boron and fluorine, the boron-containing compound is in a molten state during sintering, which facilitates uniform dispersion of granular fluoride on the surface of the high-nickel positive electrode material, thereby achieving the effects of reducing the impedance and improving the cycle retention rate.

The fluoride is present in a dotted form on the other part of the surface of the high-nickel positive electrode material, which can retain more lithium ion channels. During charging and discharging of a lithium ion secondary battery, the high-nickel positive electrode material is jointly protected by the lithium boron oxide coating a part of the surface of the high-nickel positive electrode material, and the fluoride present in a dotted form on the other part of the surface of the high-nickel positive electrode material, so as to prevent the high-nickel positive electrode material in the lithium ion secondary battery from being corroded by an electrolyte, thereby exhibiting relatively low impedance increase and good cycle performance.

In the positive electrode composite material of the present disclosure, the lithium boron oxide coating a part of the surface of the high-nickel positive electrode material, the fluoride present in a dotted form on the other part of the surface of the high-nickel positive electrode material, and a washing treatment, can effectively reduce the amount of residual lithium, suppress side reactions between the positive electrode composite material and the electrolyte in the lithium ion secondary battery, improve the initial Coulombic efficiency of the lithium ion secondary battery, improve the cycle performance of the lithium ion secondary battery, and reduce the impedance increase of the lithium ion secondary battery.

In one or more embodiments of the present disclosure, in order to more effectively improve the initial Coulombic efficiency of the lithium ion secondary battery, more effectively improve the cycle performance of the lithium ion secondary battery and more effectively reduce the impedance increase of the lithium ion secondary battery, in the described positive electrode composite material, the lithium boron oxide is uniformly covered on the surface of secondary particles and grain boundaries of primary particles of the high-nickel positive electrode material. Uniform coverage means that the thickness of the coating layer in different regions is close. The secondary particles are agglomerates consisting of the primary particles.

In one or more embodiments of the present disclosure, in order to more effectively improve the initial Coulombic efficiency of the lithium ion secondary battery, more effectively improve the cycle performance of the lithium ion secondary battery and more effectively reduce the impedance increase of the lithium ion secondary battery, in the described positive electrode composite material, the lithium boron oxide includes one or more of LiBO₂, Li₃BO₃, Li₂B₄O₇, Li₂B₂O₄ and Li₃B₃O₆.

In one or more embodiments of the present disclosure, in order to more effectively prevent side reactions between the positive electrode composite material and the electrolyte in the lithium ion secondary battery, more effectively improve the cycle performance of the lithium ion secondary battery and more effectively reduce the impedance increase of the lithium ion secondary battery, in the described positive electrode composite material, the fluoride includes LiF. In one or more embodiments of the present disclosure, the fluoride mainly includes LiF.

In one or more embodiments of the present disclosure, in order to more effectively prevent side reactions between the positive electrode composite material and the electrolyte in the lithium ion secondary battery, more effectively improve the cycle performance of the lithium ion secondary battery and more effectively reduce the impedance increase of the lithium ion secondary battery, in the described positive electrode composite material, the fluoride also includes one or more of MgF₂, AlF₃, NH₄F, MnF₄, TiF₃, ZrF₄, SrF₃ and MoF₅. Specifically, the fluoride may include a combination of LiF and one of MgF₂, AlF₃, NH₄F, MnF₄, TiF₃, ZrF₄, SrF₃ and MoF₅; or the fluoride may include a combination of LiF and more of MgF₂, AlF₃, NH₄F, MnF₄, TiF₃, ZrF₄, SrF₃ and MoF₅.

In one or more embodiments of the present disclosure, in the positive electrode composite material, the high-nickel positive electrode material has a general formula LiNiₓCo_{y}M_{1-x-y}O₂, where about 0.6≤x≤about 1, about 0≤y<about 0.4, and M is one or more of Mn, Al, Mg, Ti, Fe, Cu, Zn, Ga, Zr, Mo, Nb and W. In one or more embodiments of the present disclosure, the high-nickel positive electrode material such as LiNiₓCo_{y}Mn_{1-x-y}O₂ or LiNiₓCo_{y}Al_{1-x-y}O₂ can be generated by for example, sintering a positive electrode precursor such as NiₓCo_{y}Mn_{1-x-y}(OH)₂ or NiₓCo_{y}Al_{1-x-y}(OH)₂ with lithium hydroxide.

In one or more embodiments of the present disclosure, in the positive electrode composite material, the amount of boron element in the positive electrode composite material is in the range of about 0.01 wt % to about 0.50 wt %. By controlling the amount of boron element in the positive electrode composite material to be within the range above, it can be ensured that the lithium boron oxide is uniformly covered on a part of the surface of the high-nickel positive electrode material, which can improve the initial Coulombic efficiency of the lithium ion secondary battery, improve the cycle performance of the lithium ion secondary battery and reduce the impedance increase of the lithium ion secondary battery.

For example, the amount of the boron element in the positive electrode composite material may be in the following ranges: about 0.01 wt % to about 0.50 wt %, about 0.01 wt % to about 0.45 wt %, about 0.01 wt % to about 0.40 wt %, about 0.01 wt % to about 0.35 wt %, about 0.01 wt % to about 0.30 wt %, about 0.01 wt % to about 0.25 wt %, about 0.01 wt % to about 0.20 wt %, about 0.01 wt % to about 0.15 wt %, about 0.01 wt % to about 0.10 wt %, or about 0.05 wt % to about 0.50 wt %.

In one or more embodiments of the present disclosure, in the positive electrode composite material, the amount of fluorine element in the positive electrode composite material is in the range of about 0.01 wt % to about 1.00 wt %. By controlling the amount of the fluorine element in the positive electrode composite material to be within the range above, side reactions between the positive electrode composite material and the electrolyte in the lithium ion secondary battery can be suppressed, the cycle performance of the lithium ion secondary battery can be improved, and the impedance increase of the lithium ion secondary battery can be reduced.

Specifically, the amount of the fluorine element in the positive electrode composite material may be in the following ranges: about 0.01 wt % to about 1.00 wt %, about 0.05 wt % to about 0.95 wt %, about 0.10 wt % to about 0.90 wt %, about 0.15 wt % to about 0.85 wt %, about 0.20 wt % to about 0.80 wt %, about 0.25 wt % to about 0.75 wt %, about 0.30 wt % to about 0.70 wt %, about 0.35 wt % to about 0.65 wt %, about 0.40 wt % to about 0.60 wt %, about 0.45 wt % to about 0.55 wt %, or about 0.50 wt % to about 0.55 wt %.

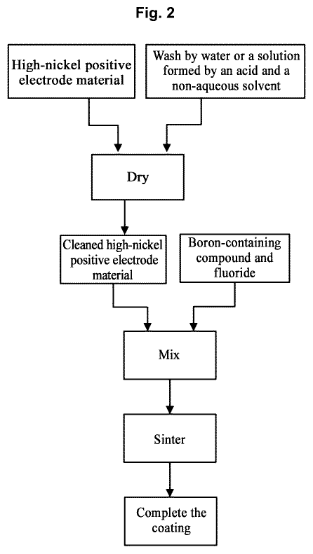

In another typical embodiment of the present disclosure, provided is a method for preparing a positive electrode composite material, the method comprising: step S1: mixing a high-nickel positive electrode material with water or a solution formed by an acid and a non-aqueous solvent, to obtain a first mixture; step S2: performing suction filtration on the first mixture to obtain a suction filtration product, and then performing vacuum drying and grinding and sieving on the suction filtration product, to obtain a washing product; step S3: performing ball-milling mixing on the washing product and a boron-containing compound and fluoride, to obtain a second mixture; and step S4: sintering the second mixture, to obtain the positive electrode composite material. FIG. 2 shows a schematic diagram of a method for preparing a positive electrode composite material according to an embodiment of the present disclosure.

A key technical point of the present disclosure is to perform a washing treatment by using water or the solution formed by an acid and a non-aqueous solvent to remove residual lithium on the surface of the high-nickel positive electrode material, to perform drying and then perform sintering to coat with the lithium boron oxide and the fluoride, so as to achieve the effect of protecting a substrate, thereby improving the cycle performance and suppressing degradation of the material. The washing treatment can reduce residual lithium on the surface of the high-nickel positive electrode material; a part of the surface of the high-nickel positive electrode material is coated with the lithium boron oxide, and the fluoride in a dotted form is present on the other part of the surface of the high-nickel positive electrode material, which can suppress side reactions between the positive electrode composite material and an electrolyte in the lithium ion secondary battery, improve the initial Coulombic efficiency of the lithium ion secondary battery, improve the cycle performance of the lithium ion secondary battery, and reduce the impedance increase of the lithium ion secondary battery; and the coating processes of boron and fluorine are simple and have a good coating effect.

The washing treatment and the boron and fluorine coating treatment can reduce the residual lithium on the surface of the high-nickel positive electrode material, improve the initial Coulombic efficiency, improve the cycle performance, and reduce the initial impedance and impedance increase; and after boron and fluorine coating, the cycle retention rate of the material is improved, and the impedance is also ameliorated.

Lithium hydroxide and lithium carbonate on the surface of the high-nickel positive electrode material can be effectively removed by the washing treatment; the coating amounts of boron and fluorine are relatively small, and as inert materials reacting with the electrolyte, they can maintain stability under a high voltage; and after a cycle, the matrix of the high-nickel positive electrode material is protected by the coating layer so as to prevent corrosion by the electrolyte, thereby exhibiting relatively low impedance increase and good cycle performance.

In one or more embodiments of the present disclosure, in the method for preparing the positive electrode composite material, in the step S1, the acid comprises an organic acid, an inorganic acid or a mixture thereof, preferably, the organic acid comprises one or more of maleic acid, acrylic acid, fumaric acid, malonic acid, oxalic acid, malic acid, glycolic acid, succinic acid, citric acid, tricarballylic acid and aconitic acid, and preferably, the inorganic acid comprises one or both of phosphoric acid and silicic acid. The organic acid, inorganic acid or a mixture thereof can well react with residual lithium on the surface of the high-nickel positive electrode material, can effectively reduce the residual lithium on the surface of the high-nickel positive electrode material, and can ensure a good washing effect.

In one or more embodiments of the present disclosure, in the described method for preparing the positive electrode composite material, in the step S1, the non-aqueous solvent comprises an alcoholic solvent, and preferably, the alcoholic solvent comprises one or more of methanol, ethanol, isopropanol, ethylene glycol and glycerol. The alcoholic solvent can serve to dissolve the acid, and the alcoholic solvent itself does not undergo additional side reactions with the high-nickel positive electrode material, thereby effectively reducing residual lithium on the surface of the high-nickel positive electrode material while suppressing the side reactions.

In one or more embodiments of the present disclosure, in order to effectively remove moisture from the material, in the method for producing a positive electrode composite material, in the step S2, the temperature of performing the vacuum drying is in the range of about 60° C. to about 150° C., and the time of performing the vacuum drying is in the range of about 0.1 h to about 12 h, preferably, the temperature of performing the vacuum drying is in the range of about 80° C. to about 130° C., and the time of performing the vacuum drying is in the range of about 3 h to about 9 h, and more preferably, the temperature of performing the vacuum drying is in the range of about 90° C. to about 120° C., and the time of performing the vacuum drying is in the range of about 6 h to about 8 h.

In one or more embodiments of the present disclosure, in order to ensure that the washing product is uniformly mixed with the boron-containing compound and the fluoride and ensure a good mixing effect, in the described method for preparing the positive electrode composite material, in the step S3, the rotational speed of performing the ball-milling mixing is in the range of about 100 rpm to about 500 rpm, and the time of performing the ball-milling mixing is in the range of about 10 min to about 2 h, preferably, the rotational speed of performing the ball-milling mixing is in the range of about 200 rpm to about 400 rpm, and the time of performing the ball-milling mixing is in the range of about 10 min to about 1 h, and more preferably, the rotational speed of performing the ball-milling mixing is in the range of about 300 rpm to about 400 rpm, and the time of performing the ball-milling mixing is in the range of about 20 min to about 40 min.

In one or more embodiments of the present disclosure, in order to more effectively prevent side reactions between the positive electrode composite material and the electrolyte in the lithium ion secondary battery, more effectively improve the cycle performance of the lithium ion secondary battery and more effectively reduce the impedance increase of the lithium ion secondary battery, in the described method for preparing the positive electrode composite material, in the step S3, the fluoride includes one or more of LiF, MgF₂, AlF₃, NH₄F, MnF₄, TiF₃, ZrF₄, SrF₃ and MoF₅. When the fluoride includes one or more of MgF₂, AlF₃, NH₄F, MnF₄, TiF₃, ZrF₄, SrF₃ and MoF₅ in the step S3, the fluoride undergoes a displacement reaction with Li in the high-nickel positive electrode material to generate LiF. Thus, the positive electrode composite material finally obtained includes a combination of LiF and one or more of MgF₂, AlF₃, NH₄F, MnF₄, TiF₃, ZrF₄, SrF₃ and MoF₅ present in a dotted form on other part of the surface of the high-nickel positive electrode material.

In one or more embodiments of the present disclosure, in order to more effectively improve the initial Coulombic efficiency of the lithium ion secondary battery, more effectively improve the cycle performance of the lithium ion secondary battery and more effectively reduce the impedance increase of the lithium ion secondary battery, in the described method for preparing the positive electrode composite material, in the step S3, the boron-containing compound includes one or both of boric acid and boron oxide.

In one or more embodiments of the present disclosure, in the method for preparing the positive electrode composite material, in the step S4, the temperature for the sintering is in the range of about 200° C. to about 600° C., and the time for the sintering is in the range of about 2 h to about 8 h. In one or more embodiments of the present disclosure, in the described method for preparing the positive electrode composite material, in the step S4, the temperature for the sintering is in the range of about 250° C. to about 500° C., and the time for the sintering is in the range of about 3 h to about 7 h; preferably, the temperature for the sintering is in the range of about 250° C. to about 400° C., and the time for the sintering is in the range of about 4 h to about 6 h; more preferably, the temperature for the sintering is in the range of about 250° C. to about 350° C., and the time for the sintering is in the range of about 4 h to about 5 h; and most preferably, the temperature for the sintering is about 300° C., and the time for the sintering is about 4 h. In one or more embodiments of the present disclosure, in the method for preparing the positive electrode composite material, in the step S4, the heating rate is in the range of about 6° C./min to about 15° C./min; preferably, the heating rate is in the range of about 6° C./min to about 12° C./min; and more preferably, the heating rate is in the range of about 8° C./min to about 10° C./min. In one or more embodiments of the present disclosure, in the method for preparing the positive electrode composite material, in the step S4, an atmosphere for the sintering is oxygen. By controlling the sintering temperature, sintering time and heating rate in the step S4 to be within the described ranges, it can be ensured that the boron-containing compound is in a molten state during sintering, which facilitates uniform dispersion of granular fluoride on the surface of the high-nickel positive electrode material, thereby achieving the effects of reducing the impedance and improving the cycle retention rate.

In still another embodiment of the present disclosure, provided is a positive electrode of a lithium ion secondary battery, the positive electrode of the lithium ion secondary battery comprising the positive electrode composite material as described above. As the positive electrode of the lithium ion secondary battery of the present disclosure comprises the positive electrode composite material as described above, the amount of residual lithium can be effectively reduced, side reactions between the positive electrode composite material and the electrolyte in the lithium ion secondary battery can be suppressed, the initial Coulombic efficiency of the lithium ion secondary battery can be improved, the cycle performance of the lithium ion secondary battery can be improved, and the impedance increase of the lithium ion secondary battery can be reduced.

In yet another embodiment of the present disclosure, provided is a lithium ion secondary battery, the lithium ion secondary battery comprising: a positive electrode, a negative electrode and a separator, the positive electrode comprising the positive electrode composite material as described above. As the lithium ion secondary battery of the present disclosure comprises the positive electrode composite material as described above, the amount of residual lithium can be effectively reduced, side reactions between the positive electrode composite material and the electrolyte in the lithium ion secondary battery can be suppressed, the initial Coulombic efficiency of the lithium ion secondary battery can be improved, the cycle performance of the lithium ion secondary battery can be improved, and the impedance increase of the lithium ion secondary battery can be reduced.

The positive electrode of the present disclosure comprises a positive electrode current collector and a positive electrode active material layer comprising the positive electrode composite material. The positive electrode active material layer is formed on both surfaces of the positive electrode current collector. A metal foil such as an aluminum foil may be used as the positive electrode current collector.

The negative electrode of the present disclosure comprises a negative electrode current collector and a negative electrode active material layer comprising a negative electrode active material. The negative electrode active material layer is formed on both surfaces of the negative electrode current collector. A metal foil such as a copper (Cu) foil, a nickel foil, or a stainless steel foil may be used as the negative electrode current collector.

The negative electrode active material layer comprises, as a negative electrode active material, one or more negative electrode materials capable of intercalating and de-intercalating lithium ions, and may comprise, as necessary, another material, for example, a negative electrode binder and/or a negative electrode conductive agent. The negative electrode active material may be selected from one or more of lithium metal, a lithium alloy, a carbon material, silicon or tin, and oxides thereof.

The separator of the present disclosure is used to separate the positive electrode from the negative electrode in the battery, and allow lithium ions to pass therethrough, while preventing current short-circuiting due to contact between the positive electrode and the negative electrode. The separator is, for example, a porous membrane formed of a synthetic resin or ceramic, and may be a laminated membrane in which two or more porous membranes are laminated. Examples of the synthetic resin comprise, for example, polytetrafluoroethylene, polypropylene and polyethylene, and the like.

In one or more embodiments of the present disclosure, when the lithium ion secondary battery is charged, for example, lithium ions are de-intercalated from the positive electrode and are intercalated into the negative electrode through the electrolyte impregnated in the separator. When the lithium ion secondary battery is discharged, for example, lithium ions are de-intercalated from the negative electrode and are intercalated into the positive electrode through the electrolyte impregnated in the separator.

Hereinafter, the present disclosure will be described in further detail in reference to examples according to an embodiment, and the present disclosure is not limited thereto.

### Example 1

Step S1: 100 g of a high-nickel positive electrode material LiNi_{0.95}Co_{0.03}Mn_{0.02}O₂ was weighed, 100 g of water was added, and stirring was performed for 1 h, to obtain a mixed solution;
step S2: suction filtration was performed on the mixed solution in step S1, the obtained suction filtration product was placed in a vacuum drying box for drying at 120° C. for 8 h, and ground and sieved, to obtain a cleaned high-nickel positive electrode material;
step S3: 0.46 g of boric acid (H₃BO₃) and 0.15 g of AlF₃ were weighed, and subjected to ball-milling mixing with the high-nickel positive electrode material in step S2 to obtain a mixture, the rotational speed of performing the ball-milling mixing was 300 rpm, and the time was 20 min;
step S4: the mixture in step S3 was placed in a tube furnace for sintering, the sintering temperature was 300° C., the sintering time was 4 hours, the heating rate was 10° C./min, and the atmosphere was oxygen; after a sample was cooled, the sample was ground and sieved to obtain a positive electrode composite material; and
step S5: 90 g of the positive electrode composite material prepared by the process above, 5 g of conductive carbon black as a conductive agent and 5 g of polyvinylidene fluoride (PVDF) as a binder were weighed, to prepare an electrode sheet, and the electrode sheet was used to prepare a button half-cell.

### Example 2

A half-cell was prepared by using the same method as that in Example 1, and the difference lies in that: in the step S1, an ethanol solution having a maleic acid concentration of 3 wt % was used instead of water.

### Example 3

A half-cell was prepared by using the same method as that in Example 1, and the difference lies in that: in the step S1, an ethanol solution having a phosphoric acid concentration of 2 wt % was used instead of water.

### Example 4

A half-cell was prepared by using the same method as that in Example 1, and the difference lies in that: in the step S1, an isopropanol solution having a maleic acid concentration of 1.5 wt % and a silicic acid concentration of 1 wt % was used instead of water.

### Example 5

A half-cell was prepared by using the same method as that in Example 1, and the difference lies in that: 0.26 g of boron oxide (B₂O₃) was used instead of 0.46 g of boric acid (H₃BO₃) in the step S3, and the sintering temperature was 500° C. in the step S4.

### Example 6

A half-cell was prepared by using the same method as that in Example 1, and the difference lies in that: in the step S3, 0.16 g of MgF₂ was used instead of 0.15 g of AlF₃.

### Example 7

A half-cell was prepared by using the same method as that in Example 1, and the difference lies in that: in the step S3, the boric acid (H₃BO₃) added was 0.91 g, and the AlF₃ added was 0.07 g.

### Example 8

A half-cell was prepared by using the same method as that in Example 1, and the difference lies in that: in the step S3, the boric acid (H₃BO₃) added was 0.23 g, and the AlF₃ added was 0.29 g.

### Example 9

A half-cell was prepared by using the same method as that in Example 1, and the difference lies in that: in the step S4, the sintering temperature was 600° C.

### Example 10

A half-cell was prepared by using the same method as that in Example 1, and the difference lies in that: in the step S4, the sintering temperature was 200° C.

### Comparative Example 1

A half-cell was prepared by using the same method as that in Example 1, and the difference lies in that: in the step S3, only 0.46 g of boric acid (H₃BO₃) was added, and no AlF₃ was added.

### Comparative Example 2

A half-cell was prepared by using the same method as that in Example 1, and the difference lies in that: in the step S3, only 0.15 g of AlF₃ was added, and no boric acid (H₃BO₃) was added.

### Comparative Example 3

A half-cell was prepared by using the same method as that in Example 1, and the difference lies in that: there were no step S3 and step S4.

### Comparative Example 4

90 g of a high-nickel positive electrode material LiNi_{0.95}Co_{0.03}Mn_{0.02}O₂, 5 g of conductive carbon black as a conductive agent and 5 g of polyvinylidene fluoride (PVDF) as a binder were weighed to prepare an electrode sheet, and the electrode sheet was used to prepare a button half-cell. The high-nickel positive electrode material was not subjected to the treatments in step S1, step S2, step S3 and step S4.

### Test of Battery Performance

The half-cells of Examples 1-10 and Comparative Examples 1-4 were subjected to a charge and discharge test and an impedance test at a voltage of 2.0 V to 4.25 V. The half-cells of Examples 1-10 and Comparative Examples 1-4 were firstly subjected to a charge and discharge cycle test of 0.1 C at 25° C. once, and then after the testing ends, the initial discharge capacity and initial impedance of the cells were tested; then the half-cells were subjected to a cycle test of 1 C charging and 5 C discharging at 60° C. for 100 times to determine the capacity retention rate after 100 cycles of the cells, and after completion, the after-cycle impedance was tested. Impedance increase rate=after-cycle impedance/initial impedance. Initial Coulombic efficiency (%)=initial discharge capacity/initial charge capacity×100%.

In addition, with regard to the positive electrode materials prepared in the above Examples 1-10 and Comparative Examples 1-4, a certain amount of positive electrode material powder was weighed, fully stirred in deionized water, and then filtered to obtain a supernatant. The supernatant was titrated by using a hydrochloric acid solution of a standard concentration to calculate the mass of lithium in the supernatant, and the mass was converted into the mass fraction of residual lithium in the positive electrode material. The experimental results are shown in the following Table 1.

TABLE 1
Electrochemical performance test results

| | | Initial | Initial | Capacity | | | Impedance |
|---|---|---|---|---|---|---|---|
| | Residual | discharge | Coulombic | retention rate | Initial | After-cycle | increase |
| Experiment | lithium | capacity | efficiency | after 100 | impedance | impedance | rate |
| No. | (wt %) | (mAh/g) | (%) | cycles (%) | (Ω) | (Ω) | (times) |
| Example 1 | 0.18 | 229 | 92.1 | 86 | 5.5 | 83 | 15 |
| Example 2 | 0.21 | 230 | 92.3 | 90 | 4.9 | 49 | 10 |
| Example 3 | 0.23 | 230 | 92.2 | 85 | 5.1 | 61 | 12 |
| Example 4 | 0.22 | 229 | 92.1 | 87 | 4.9 | 54 | 11 |
| Example 5 | 0.25 | 229 | 92.2 | 83 | 5.0 | 90 | 18 |
| Example 6 | 0.18 | 230 | 92.0 | 86 | 5.4 | 86 | 16 |
| Example 7 | 0.19 | 229 | 92.1 | 85 | 5.3 | 90 | 17 |
| Example 8 | 0.18 | 228 | 92.0 | 87 | 5.6 | 78 | 14 |
| Example 9 | 0.26 | 227 | 92.2 | 82 | 4.9 | 98 | 20 |
| Example 10 | 0.17 | 229 | 92.1 | 86 | 5.7 | 91 | 16 |
| Comparative | 0.20 | 229 | 91.8 | 75 | 6.1 | 232 | 38 |
| Example 1 | | | | | | | |
| Comparative | 0.19 | 229 | 91.7 | 78 | 7.5 | 225 | 30 |
| Example 2 | | | | | | | |
| Comparative | 0.16 | 230 | 91.9 | 65 | 54.7 | 4157 | 76 |
| Example 3 | | | | | | | |
| Comparative | 0.43 | 228 | 91.9 | 54 | 10.2 | 602 | 59 |
| Example 4 | | | | | | | |

It can be seen from the test results that the examples above of the present disclosure achieve the following technical effects:

By comparing the results of Examples 1-10 with those of Comparative Example 1, it can be seen that, compared with Comparative Example 1 in which no fluoride exists on the surface of the high-nickel positive electrode material, the cells of Examples 1-10 in which a part of the surface of the high-nickel positive electrode material is coated with the lithium boron oxide and the fluoride in a dotted form is present on the other part of the surface of the high-nickel positive electrode material have higher initial Coulombic efficiency, significantly higher capacity retention rate after 100 cycles, significantly lower initial impedance and significantly lower impedance increase rate. In particular, comparing Example 1 with Comparative Example 1 in which the conditions in steps S1-S2 and S4 are completely the same, it can be seen that compared with Comparative Example 1 in which no fluoride exists on the surface of the high-nickel positive electrode material, the cell of Example 1 in which a part of the surface of the high-nickel positive electrode material is coated with the lithium boron oxide and the fluoride in a dotted form is present on the other part of the surface of the high-nickel positive electrode material has higher initial Coulombic efficiency, significantly higher capacity retention rate after 100 cycles, significantly lower initial impedance and significantly lower impedance increase rate, and the positive electrode composite material in Example 1 has a lower residual lithium amount.

By comparing the results of Examples 1-10 with those of Comparative Example 2, it can be seen that, compared with Comparative Example 2 in which no lithium boron oxide exists on the surface of the high-nickel positive electrode material, the cells of Examples 1-10 in which a part of the surface of the high-nickel positive electrode material is coated with the lithium boron oxide and the fluoride in a dotted form is present on the other part of the surface of the high-nickel positive electrode material have higher initial Coulombic efficiency, significantly higher capacity retention rate after 100 cycles, significantly lower initial impedance and significantly lower impedance increase rate. In particular, comparing Example 1 with Comparative Example 2 in which the conditions in steps S1-S2 and S4 are completely the same, it can be seen that compared with Comparative Example 2 in which no lithium boron oxide exists on the surface of the high-nickel positive electrode material, the cell of Example 1 in which a part of the surface of the high-nickel positive electrode material is coated with the lithium boron oxide and the fluoride in a dotted form is present on the other part of the surface of the high-nickel positive electrode material has higher initial Coulombic efficiency, significantly higher capacity retention rate after 100 cycles, significantly lower initial impedance and significantly lower impedance increase rate, and the positive electrode composite material in Example 1 has a lower residual lithium amount.

By comparing the results of Examples 1-10 with those of Comparative Example 3, it can be seen that, compared with Comparative Example 3 in which no lithium boron oxide and fluoride exist on the surface of the high-nickel positive electrode material, the cells of Examples 1-10 in which a part of the surface of the high-nickel positive electrode material is coated with the lithium boron oxide and the fluoride in a dotted form is present on the other part of the surface of the high-nickel positive electrode material have higher initial Coulombic efficiency, significantly higher capacity retention rate after 100 cycles, significantly lower initial impedance and significantly lower impedance increase rate. In particular, comparing Examples 1 and 5-10 with Comparative Example 3 in which the conditions in steps S1-S2 are completely the same, it can be seen that compared with Comparative Example 3 in which no lithium boron oxide and fluoride exist on the surface of the high-nickel positive electrode material, the cells of Examples 1 and 5-10 in which a part of the surface of the high-nickel positive electrode material is coated with the lithium boron oxide and the fluoride in a dotted form is present on the other part of the surface of the high-nickel positive electrode material have higher initial Coulombic efficiency, significantly higher capacity retention rate after 100 cycles, significantly lower initial impedance and significantly lower impedance increase rate.

By comparing the results of Examples 1-10 with those of Comparative Example 4, it can be seen that compared with Comparative Example 4 in which the high-nickel positive electrode material was not subjected to the treatments in step S1, step S2, step S3 and step S4, the cells of Examples 1-10 in which a washing treatment is performed, a part of the surface of the high-nickel positive electrode material is coated with the lithium boron oxide and the fluoride in a dotted form is present on the other part of the surface of the high-nickel positive electrode material have higher initial Coulombic efficiency, significantly higher capacity retention rate after 100 cycles, significantly lower initial impedance and significantly lower impedance increase rate, and the positive electrode composite materials in Examples 1-10 have lower residual lithium amounts.

It can be seen from the described battery performance test results: by the positive electrode composite material, the method for preparing the positive electrode composite material, and the positive electrode and the lithium ion secondary battery which comprise the positive electrode composite material in the present disclosure, the amount of residual lithium can be effectively reduced, side reactions between the positive electrode composite material and the electrolyte in the lithium ion secondary battery can be suppressed, the initial Coulombic efficiency of the lithium ion secondary battery can be improved, the cycle performance of the lithium ion secondary battery can be improved and the impedance increase of the lithium ion secondary battery can be reduced.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A positive electrode composite material comprising:
a high-nickel positive electrode material;
a lithium boron oxide coating a part of a surface of the high-nickel positive electrode material; and
a fluoride present in a dotted form on an other part of the surface of the high-nickel positive electrode material,
wherein an amount of residual lithium on a surface of the positive electrode composite material is less than about 0.3 wt %.

2. The positive electrode composite material according to claim 1, wherein the lithium boron oxide is uniformly covered on a surface of secondary particles and grain boundaries of primary particles of the high-nickel positive electrode material.

3. The positive electrode composite material according to claim 1, wherein the lithium boron oxide includes one or more of LiBO₂, Li₃BO₃, Li₂B₄O₇, Li₂B₂O₄ and Li₃B₃O₆.

4. The positive electrode composite material according to claim 1, wherein the fluoride includes LiF.

5. The positive electrode composite material according to claim 4, wherein the fluoride also includes one or more of MgF₂, AlF₃, NH₄F, MnF₄, TiF₃, ZrF₄, SrF₃ and MoF₅.

6. The positive electrode composite material according to claim 1, wherein the high-nickel positive electrode material has a general formula LiNiₓCo_{y}M_{1-x-y}O₂, where about 0.6≤x≤about 1, about 0≤y<about 0.4, and M is one or more of Mn, Al, Mg, Ti, Fe, Cu, Zn, Ga, Zr, Mo, Nb and W.

7. The positive electrode composite material according to claim 1, wherein an amount of boron element in the positive electrode composite material is about 0.01 wt % to about 0.50 wt %.

8. The positive electrode composite material according to claim 1, wherein an amount of fluorine element in the positive electrode composite material is about 0.01 wt % to about 1.00 wt %.

9. A method for preparing a positive electrode composite material, wherein the method comprising:
mixing a high-nickel positive electrode material with water or a solution formed by an acid and a non-aqueous solvent, to obtain a first mixture;
performing suction filtration on the first mixture to obtain a suction filtration product, and then performing vacuum drying and grinding and sieving on the suction filtration product, to obtain a washing product;
performing ball-milling mixing on the washing product and a boron-containing compound and fluoride, to obtain a second mixture; and
sintering the second mixture, to obtain the positive electrode composite material.

10. The method for preparing the positive electrode composite material according to claim 9, wherein the acid comprises an organic acid, an inorganic acid or a mixture thereof.

11. The method for preparing the positive electrode composite material according to claim 9, wherein the non-aqueous solvent comprises an alcoholic solvent, and preferably, the alcoholic solvent comprises one or more of methanol, ethanol, isopropanol, ethylene glycol and glycerol.

12. The method for preparing the positive electrode composite material according to claim 9, wherein a temperature of performing the vacuum drying is about 60° C. to about 150° C., and a time of performing the vacuum drying is about 0.1 h to about 12 h.

13. The method for preparing the positive electrode composite material according to claim 9, wherein a rotational speed of performing the ball-milling mixing is about 100 rpm to about 500 rpm, and a time of performing the ball-milling mixing is about 10 min to about 2 h.

14. The method for preparing the positive electrode composite material according to claim 9, wherein the fluoride includes one or more of LiF, MgF₂, AlF₃, NH₄F, MnF₄, TiF₃, ZrF₄, SrF₃ and MoF₅.

15. The method for preparing the positive electrode composite material according to claim 9, wherein the boron-containing compound includes one or both of boric acid and boron oxide.

16. The method for preparing the positive electrode composite material according to claim 9, wherein a temperature for the sintering is about 200° C. to about 600° C., and a time for the sintering is about 2 h to about 8 h.

17. A positive electrode of a lithium ion secondary battery, wherein the positive electrode of the lithium ion secondary battery comprises the positive electrode composite material according to claim 1.

18. A lithium ion secondary battery, wherein the lithium ion secondary battery comprises:
a positive electrode,
a negative electrode, and
a separator,
wherein the positive electrode comprises the positive electrode composite material according to claim 1.
